(19) United States
(12) Patent Application Publication
(10) Pub. No.: US 2023/0021612 A1
(43) Pub. Date: Jan. 26, 2023

(54) INFORMATION PROVISION DEVICE, INFORMATION PROVISION METHOD, AND STORAGE MEDIUM

(71) Applicant: TOYOTA JIDOSHA KABUSHIKI KAISHA, Aichi-ken (JP)

(72) Inventors: Masato ENDO, Nagoya-shi, (JP); Yasuyuki KAMEZAKI, Toyota-shi, (JP); Yasuhiro MURATA, Toyota-shi (JP); Takeo MORIAI, Nagakute-shi (JP); Kosuke SAKAKIBARA, Toyota-shi (JP); Kenta MIYAHARA, Okazaki-shi (JP); Takashi HAYASHI, Nagoya-shi (JP)

(21) Appl. No.: 17/832,703

(22) Filed: Jun. 6, 2022

(30) Foreign Application Priority Data
Jul. 26, 2021 (JP) 2021-121744

(51) Int. Cl. G07C 5/00; G07C 5/08

(52) U.S. Cl. CPC G07C 5/006; G07C 5/0825; G07C 5/0808; G07C 5/008

(57) ABSTRACT

In an information provision server as an information provision device, a processor is configured to receive vehicle information on a vehicle, generate maintenance recommendation information for prompting a user to implement maintenance of the vehicle based on the vehicle information, and provide the user with the maintenance recommendation information and value information that is usable when the maintenance is implemented based on the maintenance recommendation information.

### CROSS-REFERENCE TO RELATED APPLICATION

This application claims priority to Japanese Patent Application No. 2021-121744 filed on Jul. 26, 2021, incorporated herein by reference in its entirety.

### BACKGROUND

### 1. Technical Field

The present disclosure relates to an information provision device, an information provision method, and a storage medium for providing information to a user of a vehicle.

### 2. Description of Related Art

Japanese Unexamined Patent Application Publication No. 2001-296915 (JP 2001-296915 A) discloses a remote self-diagnostic system that can ensure operation of a vehicle in good condition all the time by transferring status information of the vehicle to an external device such as a home server, managing the status information, and instructing a user to implement maintenance or automatically transmitting a notification of a maintenance request to a car dealer based on the status.

### SUMMARY

When vehicle information is collected for prompting a user to implement maintenance of a vehicle, there is room for improvement in order to promote provision of the vehicle information in the technique described in JP 2001-296915 A.

An object of the present disclosure is to provide an information provision device, an information provision method, and a storage medium capable of promoting provision of vehicle information when the vehicle information on a vehicle is connected for prompting maintenance of the vehicle.

An information provision device according to a first aspect of the present disclosure includes a processor. The processor is configured to receive vehicle information on a vehicle, generate, based on the vehicle information, maintenance recommendation information for prompting a user to implement maintenance of the vehicle, and provide the user with the maintenance recommendation information and value information that is usable when the maintenance is implemented based on the maintenance recommendation information.

In the information provision device according to the first aspect, the processor is configured to generate, based on the vehicle information, the maintenance recommendation information for prompting the user to implement the maintenance of the vehicle, and provide the user with the maintenance recommendation information. Here, in the information provision device above, the processor provides the user with the value information that is usable when the maintenance is implemented, together with the maintenance recommendation information. Therefore, according to the information provision device above, when the vehicle information on the vehicle is collected for prompting the maintenance of the vehicle, a burden of a maintenance cost of the user can be reduced, whereby provision of the vehicle information to the user can be promoted.

In the first aspect above, the information provision device may further include a memory. The processor may store a maintenance history in the memory, and update the maintenance history when implementation of the maintenance corresponding to the maintenance recommendation information is detected based on the vehicle information.

According to the information provision device configured as described above, it is possible to manage the maintenance history of the vehicle based on the vehicle information.

In the information provision device according to the above aspect, the processor may provide the value information that is more valuable to be provided as a period from when the maintenance recommendation information is provided to when the maintenance of the vehicle is implemented becomes shorter.

According to the information provision device configured as described above, as the period from when maintenance is recommended to when the maintenance is implemented becomes shorter, the burden of the maintenance cost of the user can be reduced, whereby the user can be prompted to implement the maintenance at an early stage.

In the aspect above, the processor may generate the maintenance recommendation information when the processor determines at least any of cases that a component of the vehicle is changed, there is a portion deviating from a reference value in the vehicle, and a predetermined period has elapsed or the vehicle has traveled a predetermined distance after replacement of the component, based on the vehicle information.

According to the information provision device configured as described above, maintenance can be recommended in any of the conditions requiring maintenance, such as the cases that the component of the vehicle is changed, there is a portion deviating from the reference value in the vehicle, and a predetermined period has elapsed or the vehicle has traveled a predetermined distance after the replacement of the component.

In an information provision method according to a second aspect of the present disclosure, a computer executes processes including: receiving vehicle information on a vehicle; generating, based on the vehicle information, maintenance recommendation information for prompting a user to implement maintenance of the vehicle, and providing the user with the maintenance recommendation information and value information that is usable when the maintenance is implemented based on the maintenance recommendation information.

In the second aspect described above, the computer is configured to generate, based on the vehicle information, the maintenance recommendation information for prompting the user to implement maintenance of the vehicle, and provide the user with the maintenance recommendation information. Here, in the information provision method above, the computer provides the user with the value information that is usable when the maintenance is implemented, together with the maintenance recommendation information. Therefore, according to the information provision method above, when the vehicle information on the vehicle is collected for prompting the maintenance of the vehicle, the burden of the maintenance cost of the user can be reduced, whereby provision of the vehicle information to the user can be promoted.

A storage medium according to a third aspect of the present disclosure stores a program that causes a computer to execute processes including: receiving vehicle information on a vehicle; generating, based on the vehicle information, maintenance recommendation information for prompting a user to implement maintenance of the vehicle; and providing the user with the maintenance recommendation information and value information that is usable when the maintenance is implemented based on the maintenance recommendation information.

The computer that executes the program stored in the storage medium according to the third aspect above is configured to generate, based on the vehicle information, the maintenance recommendation information for prompting the user to implement maintenance of the vehicle, and provide the user with the maintenance recommendation information. Here, the computer provides the user with the value information that is usable when the maintenance is implemented, together with the maintenance recommendation information. Therefore, according to the program above, when the vehicle information on the vehicle is collected for prompting the maintenance of the vehicle, the burden of the maintenance cost of the user can be reduced, whereby provision of the vehicle information to the user can be promoted.

According to the present disclosure, when the vehicle information on the vehicle is collected for promoting maintenance of the vehicle, provision of the vehicle information can be promoted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a vehicle diagnostic system according to a first embodiment;

FIG. 2 is a block diagram showing a hardware configuration of a vehicle according to the first embodiment;

FIG. 3 is a block diagram showing a hardware configuration of an information provision server according to the first embodiment;

FIG. 4 is a block diagram showing a functional configuration of the information provision server according to the first embodiment;

FIG. 5 is a sequence diagram showing a flow of processes in the vehicle diagnostic system according to the first embodiment; and

FIG. 6 is a flowchart showing a flow of a determination process executed in the information provision server according to the first embodiment.

### DETAILED DESCRIPTION OF EMBODIMENTS

A vehicle diagnostic system including an information provision device according to the present disclosure will be described. The vehicle diagnostic system is a system that prompts a user of a vehicle to implement maintenance when the vehicle needs to be maintained.

### First Embodiment

### Overall Structure

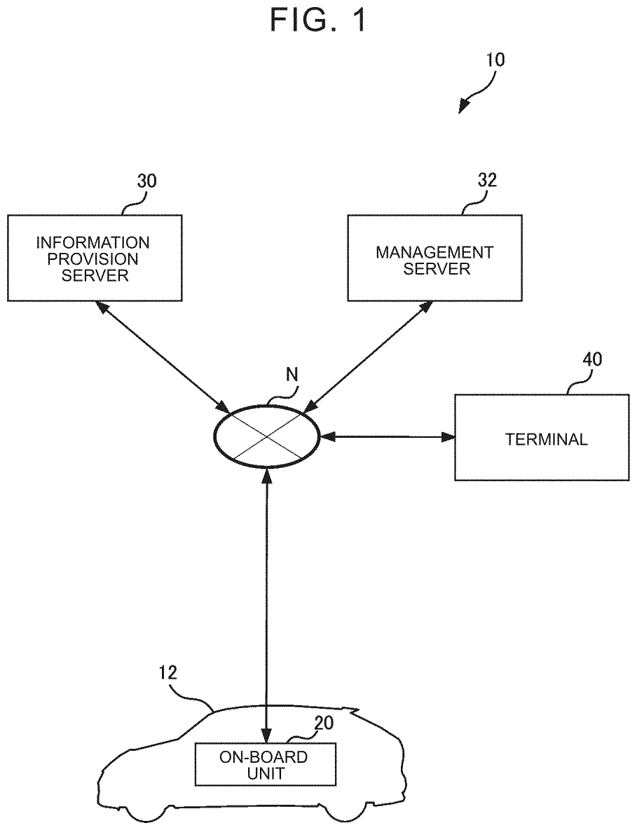

As shown in FIG. 1, a vehicle diagnostic system 10 according to the first embodiment is configured to include a vehicle 12, an information provision server 30 as an information provision device, a management server 32, and a terminal 40. Further, the vehicle 12 is equipped with an on-board unit 20. The on-board unit 20, the information provision server 30, the management server 32, and the terminal 40 are connected to each other through a network N. Note that FIG. 1 shows one vehicle 12, one on-board unit 20, one management server 32, and one terminal 40 for one information provision server 30. However, the numbers of the vehicles 12, the on-board units 20, the management servers 32, and the terminals 40 are not limited to the above.

The information provision server 30 is installed in, for example, a manufacturer that manufactures the vehicle 12 or a car dealer affiliated with the manufacturer. The management server 32 is installed in, for example, a car dealer or a maintenance shop that maintains the vehicle 12. Examples of the terminal 40 include a smartphone or a personal computer owned by a user of the vehicle 12. Examples of the user of the vehicle 12 include an owner and a driver of the vehicle 12.

### Vehicle

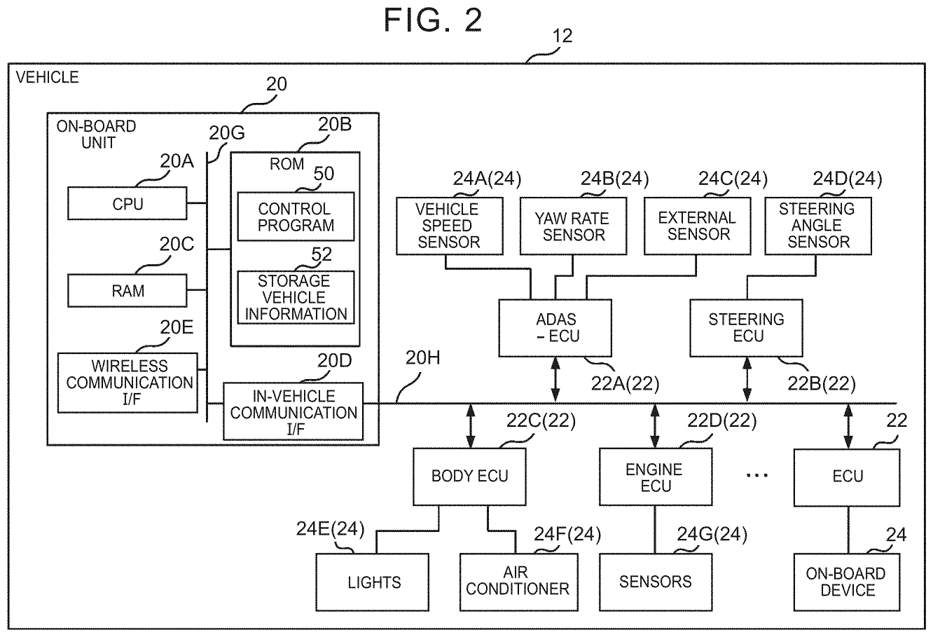

As shown in FIG. 2, the vehicle 12 according to the present embodiment includes the on-board unit 20, a plurality of electronic control units (ECUs) 22, and a plurality of on-board devices 24.

The on-board unit 20 includes a central processing unit (CPU) 20A, a read-only memory (ROM) 20B, a random access memory (RAM) 20C, an in-vehicle communication interface (MIF) 20D, and a wireless communication I/F 20E. The CPU 20A, the ROM 20B, the RAM 20C, the in-vehicle communication I/F 20D, and the wireless communication I/F 20E are connected so as to be able to communicate with each other via an internal bus 20G.

The CPU 20A is a central processing unit that executes various programs and controls various units. That is, the CPU 20A reads the program from the ROM 20B and executes the program using the RAM 20C as a work area.

The ROM 20B stores various programs and various data. The ROM 20B according to the present embodiment stores a control program 50 that collects vehicle information related to a status and control of the vehicle 12 from the ECUs 22, and executes control to provide the vehicle information to the information provision server 30. Further, the ROM 20B stores storage vehicle information 52 that is backup data of the vehicle information. The RAM 20C temporarily stores a program or data as a work area.

The in-vehicle communication I/F 20D is an interface for connecting to each of the ECUs 22. For the interface, a communication standard based on a controller area network (CAN) protocol is used. The in-vehicle communication I/F 20D is connected to an external bus 20H.

The wireless communication I/F 20E is a wireless communication module for communicating with the information provision server 30. For the wireless communication module, for example, communication standards such as fifth generation (5G), long term evolution (LTE), and Wi-Fi (registered trademark) are used. The wireless communication I/F 20E is connected to the network N.

The ECUs 22 include at least an advanced driver assistance system (ADAS)-ECU 22A, a steering ECU 22B, a body ECU 22C, and an engine ECU 22D.

The ADAS-ECU 22A controls an advanced driver assistance system in an integrated manner. A vehicle speed sensor 24A, a yaw rate sensor 24B, and an external sensor 24C that constitute the on-board devices 24 are connected to the ADAS-ECU 22A. The external sensor 24C is a group of sensors used for detecting the surrounding environment of the vehicle 12. The external sensor 24C includes, for example, a camera that captures images of surrounding areas of the vehicle 12, a millimeter-wave radar that transmits an exploration wave and receives a reflective wave, a laser imaging detection and ranging (LiDAR) that scans a front area of the vehicle 12, and the like.

The steering ECU 22B controls power steering. A steering angle sensor 24D constituting the on-board devices 24 is connected to the steering ECU 22B. The steering angle sensor 24D is a sensor that detects the steering angle of the steering wheel.

The body ECU 22C controls each portion of the body of the vehicle 12. Lights 24E and an air conditioner 24F constituting the on-board devices 24 are connected to the body ECU 22C.

The engine ECU 22D controls an engine of the vehicle 12. Sensors 24G constituting the on-board devices 24 are connected to the engine ECU 22D. The sensors 24G include an oil temperature sensor for measuring the oil temperature of engine oil, an oil pressure sensor for measuring the oil pressure of the engine oil, and a rotation sensor for detecting a rotation speed of the engine.

### Information Provision Server

The information provision server 30 acquires vehicle information from the on-board unit 20 of the vehicle 12, determines whether maintenance of the vehicle 12 is necessary, and transmits maintenance recommendation information for prompting maintenance of the vehicle 12 to the on-board unit 20 when the maintenance is necessary. Further, when transmitting the maintenance recommendation information, the information provision server 30 transmits value information that can be used when the vehicle 12 is maintained and the maintenance recommendation information to the on-board unit 20.

Here, the maintenance recommendation information is information including a component of the vehicle 12 requiring maintenance and contents of the maintenance. Examples of the maintenance include replacement and adjustment of the component of the vehicle 12, replacement or replenishment of greases and fluids of the vehicle 12, and the like. Further, the component of the vehicle 12 is not limited to each of the on-board devices 24, and includes a component that is not connected to the ECU 22, such as tires.

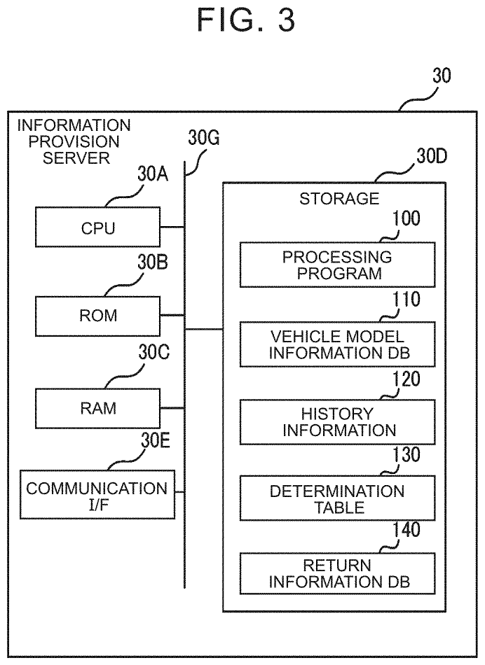

As shown in FIG. 3, the information provision server 30 includes a CPU 30A, a ROM 30B, a RAM 30C, a storage 30D, and a communication I/F 30E. The CPU 30A, the ROM 30B, the RAM 30C, the storage 30D, and the communication I/F 30E are connected so as to be able to communicate with each other via an internal bus 30G. The functions of the CPU 30A, the ROM 30B, the RAM 30C and the communication I/F 30E are the same as those of the CPU 20A, the ROM 20B, the RAM 20C and the wireless communication I/F 20E of the on-board unit 20 described above. The communication I/F 30E may perform wired communication.

The storage 30D as a memory is composed of a hard disk drive (HDD) or a solid state drive (SSD), and stores various programs and various data. The storage 30D according to the present embodiment stores a processing program 100, a vehicle model information database (DB) 110, history information 120, a determination table 130, and a return information DB 140. The ROM 30B may store the processing program 100, the vehicle model information DB 110, the history information DB 120, the determination table 130, and the return information DB 140.

The processing program 100 as a program is a program for controlling the information provision server 30. Along with the execution of the processing program 100, the information provision server 30 executes each process including a determination process for determining whether maintenance of the vehicle 12 is necessary and a value information generation process for generating value information.

The vehicle model information DB 110 is a database in which information on equipment for each vehicle mode, and the useful life or the replacement cycle of each component are stored.

The history information 120 stores information on maintenance history related to the vehicle 12 registered in the information provision server 30.

The determination table 130 stores information to be referred to when the information provision server 30 determines whether maintenance is necessary. For example, the determination table 130 stores threshold values of physical quantities for determining that maintenance is necessary, such as the threshold values of the useful life or replacement cycle of the component, the operating voltage when the component is used, and the temperature.

The return information DB 140 stores a return rate of the consideration required for maintenance for each maintenance menu.

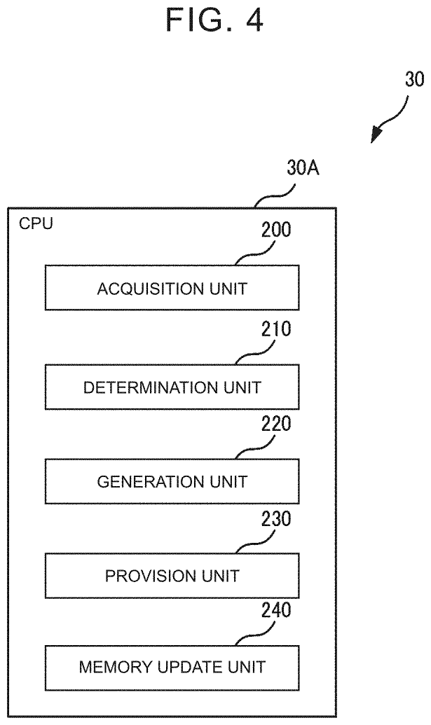

As shown in FIG. 4, in the information provision server 30 according to the present embodiment, the CPU 30A functions as an acquisition unit 200, a determination unit 210, a generation unit 220, a provision unit 230, and a memory update unit 240 by executing the processing program 100.

The acquisition unit 200 has a function of acquiring the vehicle information related to the status and control of the vehicle 12 from the on-board unit 20 of the vehicle 12. The acquisition unit 200 requests the on-board unit 20 to transmit the vehicle information periodically or at an arbitrary timing, and acquires the vehicle information transmitted from the on-board unit 20 in response to the request.

The determination unit 210 has a function of determining whether maintenance is necessary for the vehicle 12 from which the vehicle information is transmitted based on the vehicle information acquired by the acquisition unit 200. Specifically, based on the vehicle information, when the component of the vehicle 12 is changed, the determination unit 210 determines that maintenance to replace the component is necessary. For example, when the battery voltage acquired from the vehicle information is lower than a reference value, the determination unit 210 determines that maintenance to replace the battery is necessary. Here, a change in the component is a concept including degradation of performance and quality, deterioration, and the like.

Further, based on the vehicle information, when there is a portion deviating from the reference value in the vehicle 12, the determination unit 210 determines that maintenance for adjustment is necessary. For example, based on the vehicle information, when an error with respect to 0 degree of the steering angle exceeds the threshold value even though the vehicle 12 is traveling straight, the determination unit 210 determines that maintenance for adjusting the alignment is necessary. Further, the determination unit 210 determines that maintenance for replacement or adjustment is necessary when a predetermined period has elapsed or the vehicle has traveled a predetermined distance after the replacement of the component, based on the vehicle information. For example, when the vehicle has traveled a predetermined distance from the time of the previous change of engine oil, the determination unit 210 determines that maintenance to change the engine oil is necessary. When the determination unit 210 determines that the vehicle 12 needs maintenance, the determination unit 210 generates the maintenance recommendation information for prompting the maintenance of the vehicle 12.

The generation unit 220 has a function of generating the value information trigged that the maintenance recommendation information is generated. The value information may be information on a coupon with which a component cost and a maintenance cost can be discounted, or may be information on the component cost and the maintenance cost after the list price is discounted. The value information according to the present embodiment includes information on the date of generation.

The provision unit 230 has a function of providing the maintenance recommendation information and the value information to the on-board unit 20 of the vehicle 12 and the terminal 40.

The memory update unit 240 has a function of updating the maintenance history stored in the history information 120. Specifically, when the memory update unit 240 receives maintenance completion information indicating that the maintenance is completed from the on-board unit 20 of the vehicle 12 that has been maintained or the management server 32 of the car dealer or the like that has implemented the maintenance, the memory update unit 240 updates the maintenance history of the vehicle 12.

### Flow of Control

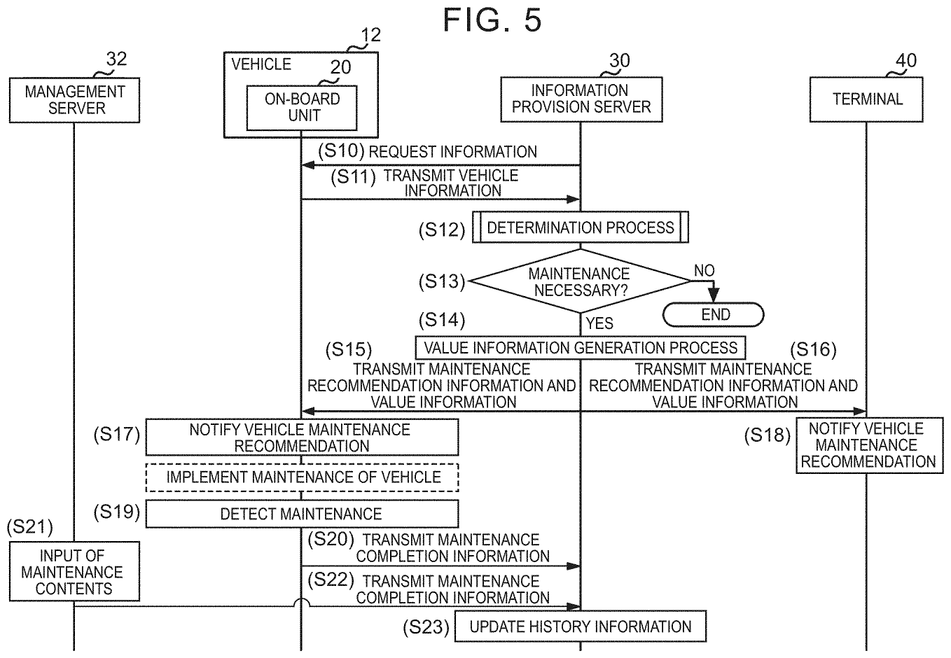

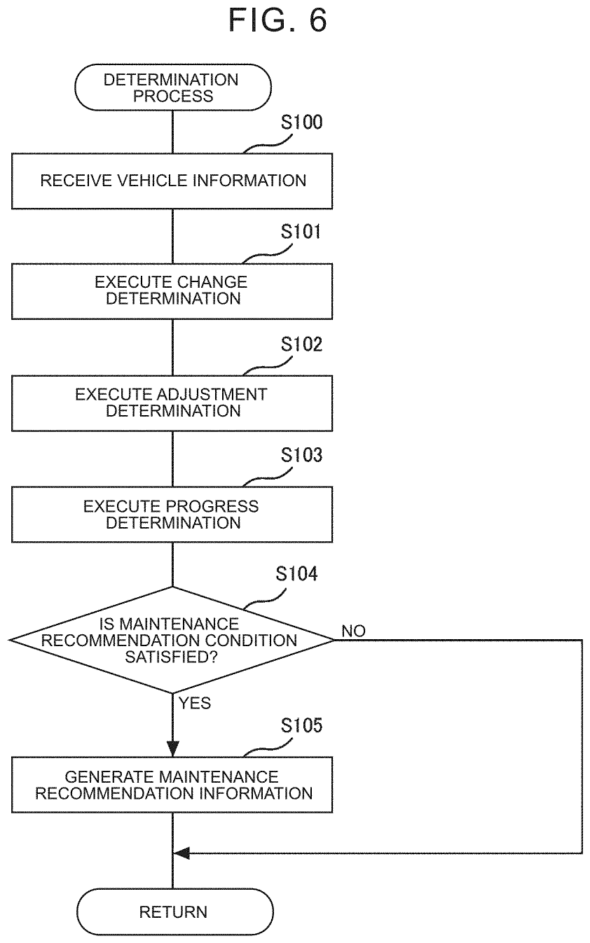

The flow of process as an information provision method executed by the vehicle diagnostic system 10 according to the present embodiment will be described with reference to a sequence diagram shown in FIG. 5 and a flowchart shown in FIG. 6. The processes in the information provision server 30 are executed as the CPU 30A of the information provision server 30 functions as the acquisition unit 200, the determination unit 210, the generation unit 220, the provision unit 230, and the memory update unit 240.

In step S10 shown in FIG. 5, in the information provision server 30, the CPU 30A makes an information request to the on-board unit 20 of the vehicle 12. For example, the CPU 30A transmits a command requesting a return of the vehicle information to the on-board unit 20 as the information request periodically or based on an instruction by the user of the vehicle 12.

In step S11, in the on-board unit 20 that receives the information request, the CPU 20A transmits the vehicle information to the information provision server 30.

In step S12, in the information provision server 30, the CPU 30A executes the determination process. Details of the determination process will be described below. When maintenance of the vehicle 12 is necessary as a result of the determination process, the maintenance recommendation information is generated.

In step S13, in the information provision server 30, the CPU 30A determines whether maintenance of the vehicle 12 is necessary. When the CPU 30A determines that maintenance of the vehicle 12 is necessary (YES in step S13), the process proceeds to step S14. On the other hand, when the CPU 30A determines that maintenance of the vehicle 12 is not necessary (NO in step S13), the subsequent processes end.

In step S14, in the information provision server 30, the CPU 30A executes the value information generation process. That is, the CPU 30A generates the value information corresponding to the maintenance recommendation information, that is, the value information in accordance with the contents of maintenance determined to be necessary in the determination process.

In step S15, in the information provision server 30, the CPU 30A transmits the maintenance recommendation information and the value information to the on-board unit 20.

In step S16, in the information provision server 30, the CPU 30A transmits the maintenance recommendation information and the value information to the terminal 40.

In step S17, in the on-board unit 20 that receives the maintenance recommendation information and the value information, the CPU 20A notifies the user of the maintenance recommendation. With the above, for example, in a center display for car navigation or a meter display, a screen prompting maintenance is displayed, together with a recommended maintenance menu and a maintenance cost.

In step S18, the terminal 40 that receives the maintenance recommendation information and the value information notifies the user of the maintenance recommendation. With the above, for example, a screen prompting maintenance is displayed on the screen of the smartphone that is the terminal 40, together with the recommended maintenance menu and the maintenance cost.

Here, it is assumed that the user who is recommended for maintenance of the vehicle 12 brings the vehicle 12 to a car dealer or the like and receives the recommended maintenance. In this case, the process below is executed.

Steps S19 and S20 are examples of cases where the vehicle 12 detects maintenance and notifies the information provision server 30 of the completion of maintenance.

First, in step S19, in the on-board unit 20, the CPU 20A detects implementation of the maintenance based on the vehicle information. For example, when the CPU 20A detects that the amount of insufficient engine oil or brake fluid turns into an appropriate amount based on the vehicle information, the CPU 20A detects that the vehicle 12 has been maintained. Further, when the mechanic or the user performs a reset operation or the like, the CPU 20A detects that the vehicle 12 has been maintained.

In step S20, in the on-board unit 20 that detects the maintenance, the CPU 20A transmits the maintenance completion information indicating that the maintenance is completed to the information provision server 30. The maintenance completion information includes information such as portions that have been maintained and contents of the maintenance.

Step S21 and step S22 are examples in which the car dealer or the like that has implemented the maintenance notifies the information provision server 30 of the completion of the maintenance.

First, in step S21, the CPU of the management server 32 receives an input of the contents of the maintenance from the mechanic or the like. For example, the mechanic who has performed maintenance work on the vehicle 12 inputs the maintained portions and the contents of the maintenance to the management server 32 via an input device such as a keyboard or a touch panel.

In step S22, in the management server 32 to which the contents of the maintenance are input, the CPU transmits the maintenance completion information to the information provision server 30. The maintenance completion information is as described above.

In step S23, in the information provision server 30, the CPU 30A updates the history information. That is, the CPU 30A updates the history information 120 by storing a new maintenance history based on the maintenance completion information.

Next, details of the determination process in step S12 will be described. In step S100 shown in FIG. 6, the CPU 30A receives the vehicle information.

In step S101, the CPU 30A executes a change determination. Specifically, among the processes of the determination unit 210 described above, the CPU 30A determines whether the component of the vehicle 12 is changed based on the vehicle information.

In step S102, the CPU 30A executes an adjustment determination. Specifically, among the processes of the determination unit 210 described above, the CPU 30A determines whether there is a portion deviating from the reference value in the vehicle 12 based on the vehicle information.

In step S103, the CPU 30A executes a progress determination. Specifically, among the processes of the determination unit 210 described above, the CPU 30A determines whether a predetermined period has elapsed or whether the vehicle has traveled a predetermined distance after the replacement of the component, based on the vehicle information.

In step S104, the CPU 30A determines whether a maintenance recommendation condition is satisfied. Specifically, when any one of the conditions that the component of the vehicle 12 is changed, there is a portion deviating from the reference value in the vehicle 12, and a predetermined period has elapsed or the vehicle has traveled a predetermined distance after the replacement of the component is satisfied, the CPU 30A determines that the maintenance recommendation condition is satisfied. When the CPU 30A determines that the maintenance recommendation condition is satisfied (YES in step S104), the process proceeds to step S105. On the other hand, when the CPU 30A determines that the maintenance recommendation condition is not satisfied (NO in step S104), the CPU 30A ends the determination process.

In step S105, the CPU 30A generates the maintenance recommendation information. That is, as the maintenance recommendation information, information indicating that maintenance is recommended and including the recommended maintenance menu is generated. Then, the CPU 30A ends the determination process.

### SUMMARY

The information provision server 30 as the information provision device according to the present embodiment is configured to generate the maintenance recommendation information for prompting the user to maintain the vehicle 12 based on the vehicle information, and provides the user with the maintenance recommendation information via the on-board unit 20 or the terminal 40. Further, the information provision server 30 according to the present embodiment provides the user with the value information that can be used when maintenance is implemented, together with the maintenance recommendation information. Therefore, according to the present embodiment, when the vehicle information on the vehicle 12 is collected for prompting the maintenance of the vehicle 12, a burden of the maintenance cost of the user can be reduced, whereby provision of the vehicle information can be promoted.

Further, the information provision server 30 according to the present embodiment generates the maintenance recommendation information when the information provision server 30 determines at least any of the cases that the component of the vehicle 12 is changed, there is a portion deviating from the reference value in the vehicle 12, and a predetermined period has elapsed or the vehicle has traveled a predetermined distance after the replacement of the component, based on the vehicle information. Therefore, according to the present embodiment, maintenance can be recommended under any condition requiring maintenance.

Further, according to the present embodiment, the maintenance history can be updated when implementation of the maintenance corresponding to the maintenance recommendation information is detected based on the vehicle information. This makes it possible to manage the maintenance history of the vehicle based on the vehicle information.

### Second Embodiment

In a second embodiment, the following function is added to the information provision server 30 according to the first embodiment. That is, in the information provision server 30 according to the present embodiment, the CPU 30A is configured to provide the value information that is more valuable to be provided as the period from when the maintenance recommendation information is provided to when the maintenance of the vehicle 12 is implemented becomes shorter. Specifically, the CPU 30A is set with a plurality of discount rates having different expiration dates based on the date on which the value information is generated. In this case, the discount rate is set such that as a period to the expiration date becomes shorter, the discount rate increases, that is, as a period until the vehicle 12 is maintained becomes shorter, the maintenance cost is reduced.

According to the present embodiment, as the period from when maintenance is recommended to when the maintenance is implemented becomes shorter, the burden of the maintenance cost of the user can be reduced, and the user can be prompted to implement the maintenance at an early stage.

### Remarks

In the above embodiments, the information provision server 30 is used as the information provision device. However, the present disclosure is not limited to this, and the on-board unit 20 may be used as the information provision device. In this case, the on-board unit 20 collects the vehicle information on the vehicle 12 on which the on-board unit 20 is mounted, generates the maintenance recommendation information, and provides the maintenance recommendation information and the value information to the user who is on board the vehicle 12. With the above, in the center display for car navigation or the meter display, the screen prompting maintenance is displayed, together with the recommended maintenance menu and the maintenance cost.

It should be noted that various processors other than the CPU may execute the various processes that are executed when the CPU 20A and the CPU 30A read the software (program) in the above embodiments. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. Further, each process described above may be executed by one of these various processors, or by a combination of two or more processors of the same type or different types (for example, a combination of FPGAs, a combination of a CPU and an FPGA, and the like). Further, the hardware structure of each of the various processors is, more specifically, an electric circuit in which circuit elements such as semiconductor elements are combined.

Further, in the above embodiments, a mode in which each program is stored (installed) in a non-transitory computer-readable recording medium in advance has been described. The non-transitory computer-readable recording medium is an example of a storage medium. For example, the control program 50 in the on-board unit 20 is stored in advance in the ROM 20B, and the processing program 100 in the information provision server 30 is stored in advance in the storage 30D. However, the present disclosure is not limited to this, and the program may be recorded on a non-transitory recording medium such as a compact disc read-only memory (CD-ROM), a digital versatile disc read-only memory (DVD-ROM), and a universal serial bus (USB) memory to be provided. Further, the program may be downloaded from an external device via a network.

The flow of processes described in the above embodiments is an example, and unnecessary steps may be deleted, new steps may be added, or the process order may be changed within a range that does not deviate from the gist.

What is claimed is:

1. An information provision device comprising a processor, wherein the processor is configured to
receive vehicle information on a vehicle,
generate, based on the vehicle information, maintenance recommendation information for prompting a user to implement maintenance of the vehicle, and
provide the user with the maintenance recommendation information and value information that is usable when the maintenance is implemented based on the maintenance recommendation information.

2. The information provision device according to claim 1, further comprising a memory, wherein the processor
stores a maintenance history in the memory, and
updates the maintenance history when implementation of the maintenance corresponding to the maintenance recommendation information is detected based on the vehicle information.

3. The information provision device according to claim 1, wherein the processor provides the value information that is more valuable to be provided as a period from when the maintenance recommendation information is provided to when the maintenance of the vehicle is implemented becomes shorter.

4. The information provision device according to claim 1, wherein the processor generates the maintenance recommendation information when the processor determines at least any of cases that a component of the vehicle is changed, there is a portion deviating from a reference value in the vehicle, and a predetermined period has elapsed or the vehicle has traveled a predetermined distance after replacement of the component, based on the vehicle information.

5. An information processing method in which a computer executes processes comprising:
receiving vehicle information on a vehicle;
generating, based on the vehicle information, maintenance recommendation information for prompting a user to implement maintenance of the vehicle; and
providing the user with the maintenance recommendation information and value information that is usable when the maintenance is implemented based on the maintenance recommendation information.

6. A storage medium storing a program that causes a computer to execute processes comprising:
receiving vehicle information on a vehicle;
generating, based on the vehicle information, maintenance recommendation information for prompting a user to implement maintenance of the vehicle; and
providing the user with the maintenance recommendation information and value information that is usable when the maintenance is implemented based on the maintenance recommendation information.
